(19) United States
(12) Patent Application Publication
(10) Pub. No.: US 2020/0212625 A1
(43) Pub. Date: Jul. 2, 2020

(54) Electrical Connector

(71) Applicant: WEN CHUN LIN, New Taipei City (TW)

(72) Inventor: WEN CHUN LIN, New Taipei City (TW)

(21) Appl. No.: 16/234,436

(22) Filed: Dec. 27, 2018

(51) Int. Cl. H01R 13/627; H01R 12/77; H01R 12/72; H01R 13/66

(52) U.S. Cl. CPC H01R 13/6278; H01R 13/6683; H01R 12/72; H01R 12/777

(57) ABSTRACT

An electrical connector comprising a male plug and a female plug, the female plug connected to the male plug through a circuit module, and the circuit module connected to the first electrode; in particular, a sheet body is configured between the male plug and the female plug. The sheet body comprises a conducting layer connected to the second electrode. The forward projection of the conducting layer on the sheet body forms a piercing zone. The male plug pierces the sheet body through the piercing zone, snaps together with the female plug, and is electrically connected to the conducting layer. The connector of the present invention differs from conventional connectors in both structure and usage, and can be applied in various fields.

### BACKGROUND OF INVENTION

### 1. Field of the Invention

The present invention relates generally to an electrical connector, and more particularly to a connector having the structure of a male plug and a female plug.

### 2. Description of Related Art

Over the years, along with the development of the times, more and more electronic products are introduced into the market. Electric connectors are common components of various electronic products.

Traditionally, one end of the connector is connected to the positive pole, and the other end is connected to the negative pole. The electric circuit is conducted through connections of the two ends. Or, one end is connected to an electric wire of one polarity and the other end is connected to an electric wire of the other polarity, and the electric circuit is thus conducted.

However, as mentioned above, along with the evolution of technologies, structural improvements are constantly made to various electronic products. And consequently, the structure of connectors shall be further altered or improved to meet the needs of consumers or users.

### SUMMARY OF THE INVENTION

In view of the above, the present invention provides an electrical connector, comprising a male plug and a female plug. The female plug is connected to the male plug through a circuit module, and the circuit module is connected to the first electrode. In particular, a sheet body is configured between the male plug and the female plug. The sheet body has a conducting layer connected to the second electrode. The forward projection of the conducting layer on the sheet body forms a piercing zone. The male plug pierces the sheet body through the piercing zone, and snaps together with the female plug and is electrically connected to the conducting layer.

In one embodiment of the connector as described above, the circuit module comprises an electric conductive connecting wire.

In one embodiment of the connector as described above, the circuit module comprises a detector body, and the female plug is configured on the detector body.

In one embodiment of the connector as described above, the circuit module further comprises a cover body, which can be combined with the detector body, and the male plug is configured on the cover body.

In one embodiment of the connector as described above, the circuit module comprises a detector body, and the male plug is configured on the detector body.

In one embodiment of the connector as described above, the circuit module further comprises a cover body, which can be combined with the detector body, and the female plug is configured on the cover body.

In one embodiment of the connector as described above, the sheet body comprises a first side and a second side opposite to each other, and the conducting layer is configured on at least one of the first side and the second side.

In one embodiment of the connector as described above, the sheet body comprises a soft body.

In one embodiment of the connector as described above, the sheet body comprises a rigid body.

One embodiment of the connector as described above further comprises an insulating layer, configured on the first side or the second side of the conducting layer.

One embodiment or multiple embodiments of the connector as described above can be applied in multiple electronic products. One embodiment can be applied in detecting devices, while some embodiments can be applied in displaying devices. In other words, the present invention does not limit the range of application of the connector. Manufacturers or users can choose connectors like any one or more embodiments of the present invention according to their different needs.

### BRIEF DESCRIPTION OF THE DRAWINGS

FIG. 1A is a usage status view (1) of the first embodiment of the electrical connector of the present invention.

FIG. 1B is a usage status view (2) of the first embodiment of the electrical connector of the present invention.

FIG. 2A is a usage status view (1) of the second embodiment of the electrical connector of the present invention.

FIG. 2B is a usage status view (2) of the second embodiment of the electrical connector of the present invention.

FIG. 3 is an external view of the third embodiment of the electrical connector of the present invention.

FIG. 4 is an external view of the fourth embodiment of the electrical connector of the present invention.

### DETAILED DESCRIPTION OF THE INVENTION

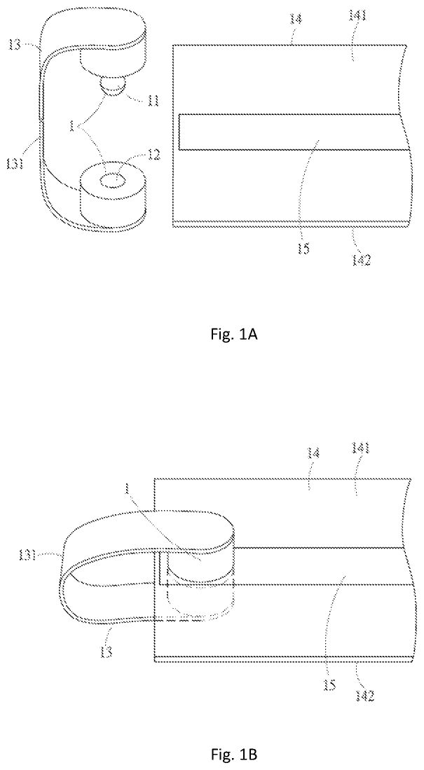

FIG. 1A and 1B are respectively the usage status view (1) and (2) of the first embodiment of the electrical connector of the present invention. The connector 1 comprises a male plug 11 and a female plug 12. The female plug 12 is connected to the male plug 11 through a circuit module 13. The circuit module 13 is connected to the first electrode, such as the positive pole. In this embodiment, the circuit module 13 comprises an electric conductive connecting wire 131. However, the present invention is not limited to this configuration. In some embodiments, it can be the main body of the electronic device (see details in the embodiments described below). The male plug 11 and the female plug 12 are snap fasteners in this embodiment, but are not limited to this, and the male plug 11 and the female plug 12 are conductive.

As shown in FIG. 1A and FIG. 1B, a sheet body 14 is configured between the male plug 11 and the female plug 12, and the sheet body 14 comprises a conducting layer 15 connected to the second electrode, such as the negative pole. The conducting layer 15 can be configured on the sheet body 14 by means of printing or coating. There is no limit in the present invention. The forward projection of the conducting layer 15 on the sheet body 14 forms a piercing zone. Said forward projection is parallel to the normal line perpendicular to the sheet body 14. The range formed by the projection toward the sheet body 14 constitutes the piercing zone. Thus, the male plug 11 pierces the sheet body 14 through the piercing zone, and when snapped together with the female plug 12, it is electrically connected to the conducting layer 15, and the circuit is conducted.

Furthermore, in some embodiments, the sheet body 14 described above can be a soft body, such as cloth or diaper. It can also be a flexible soft body having pliability. In some other embodiments, the sheet body 14 can be a rigid body, such as a plastic plate or plastic film made of resin. The present invention does not limit the material of the sheet body 14.

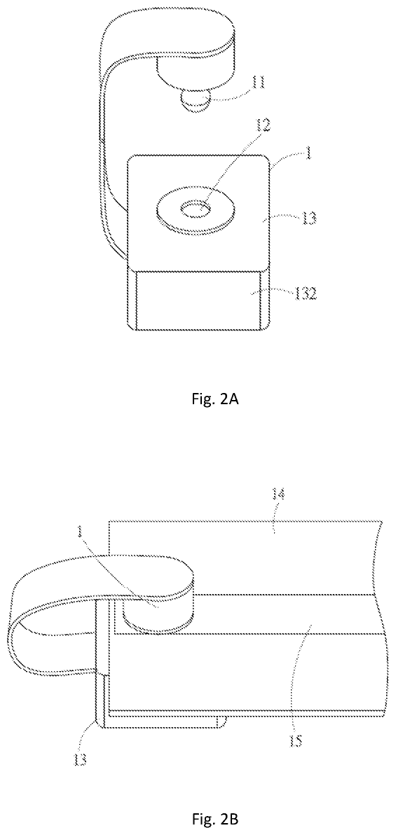

FIG. 2A and FIG. 2B are respectively the usage status view (1) and (2) of the second embodiment of the connector 1 of the present invention. In this embodiment, the connector 1 is applied in a detecting device, and the circuit module 13 is the main body of a detecting device. The female plug 12 is configured on the detector body 132. In some embodiments, the detecting device is applied in a diaper. The male plug 11 pierces the sheet body 14 (such as a diaper), and snaps together with the female plug 12 so that the circuit is conducted to detect if the baby has issue of urine leakage. However, the connector 1 and circuit module 13 of the present invention are not limited to this. In some other embodiments, the male plug 11 and the female plug 12 are exchanged in configuration, i.e., the male plug 11 can also be configured on the detector body 132. The female plug 12 pushes the sheet body 14 so that the male plug 11 pierces the sheet body 14, and the female plug 12 and the male plug 11 are snapped together, thus the circuit is conducted.

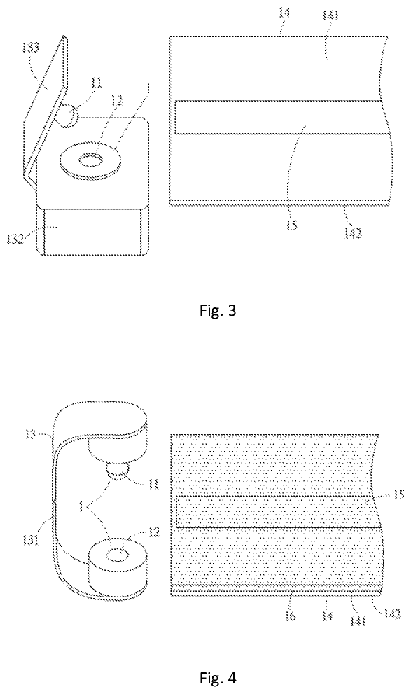

FIG. 3 is an external view of the third embodiment of the connector 1 of the present invention. Different from the embodiments disclosed in FIG. 2A and FIG. 2B, the circuit module 13 is a detecting device. In this embodiment, the detecting device comprises a cover body 133, which can be combined with the detector body 132, and the male plug 11 is configured on the cover body 133. The means of circuit conduction are similar to the first and second embodiments and are not further detailed here. In some other embodiments, the male plug 11 and the female plug 12 are exchanged in configuration, i.e., the female plug 12 is configured on the cover body 133, while the male plug 11 is configured on the detector body 132. The female plug 12 pushes the sheet body 14, so that the male plug 11 pierces the sheet body 14. When the female plug 12 and the male plug 11 are snapped together, the circuit is conducted.

The sheet body 14 of the present invention comprises a first side 141 and a second side 142 opposite to each other. The conducting layer 15 can be configured on at least one of the first side 141 and the second side 142. In the embodiment disclosed in FIG. 1A and FIG. 1B, the conducting layer 15 is configured on the first side 141. The male plug 11 firstly touches the second side 142, pierces the sheet body 14 and touches the conducting layer 15 of the first side 141. When snapped together with the female plug 12, the circuit is conducted. However, the present invention is not limited to this. In some embodiments, the conducting layer 15 can be configured both on the first side 141 and the second side 142 according to the specific needs of manufacturers or users.

FIG. 4 is an external view of the fourth embodiment of the connector 1 of the present invention. For some special applications, in this embodiment, the connector 1 further comprises an insulating layer 16, which can be configured on the opposite first side 141 or the second side 142 of the conducting layer 15, i.e., when the conducting layer 15 is configured on the second side 142, the insulating layer 16 is configured on the first side 141 of the sheet body 14, and vice versa. The purpose is to avoid external conductivity of the circuit and to reduce the risk of electric shock by mistake. Of course, electric shock by mistake is just one case. In some other cases, there may be a need that the electronic device is used under water, and requires the configuration of an insulating layer 16. In a word, there is no limit to the present invention.

The connector implemented as one or more embodiments described above differs from conventional connectors in both structure and usage. In one embodiment, it can be applied in a detecting device. In some other embodiments, it can also be applied in a displaying device. The present invention does not limit the range of application of the connector. It can be applied according to the specific needs of manufacturers or users.

1. An electrical connector, comprising:
a male plug; and
a female plug, connected to said male plug through a circuit module, said circuit module connected to a first electrode;
in particular, a sheet body is configured between said male plug and said female plug, said sheet body comprising a conducting layer connected to the second electrode, the forward projection of said conducting layer on said sheet body forming a piercing zone, said male plug piercing sheet body through said piercing zone, snapping together with said female plug and electrically connected to said conducting layer.

2. The electrical connector as claimed in claim 1, wherein said circuit module comprises an electric conductive connecting wire.

3. The electrical connector as claimed in claim 1, wherein said circuit module comprises a detector body, and said female plug is configured on said detector body.

4. The electrical connector as claimed in claim 3, wherein said circuit module further comprises a cover body, which can be combined with said detector body, and said male plug is configured on said cover body.

5. The electrical connector as claimed in claim 1, wherein said circuit module comprises a detector body, said male plug is configured on said detector body.

6. The electrical connector as claimed in claim 5, wherein said circuit module further comprises a cover body, which can be combined with said detector body, and said female plug is configured on said cover body.

7. The electrical connector as claimed in claim 1, wherein said sheet body comprises a first side and a second side opposite to each other, and said conducting layer is configured on at least one of said first side and said second side.

8. The electrical connector as claimed in claim 1, wherein said sheet body comprises a soft body.

9. The electrical connector as claimed in claim 1, wherein said sheet body comprises a rigid body.

10. The electrical connector as claimed in claim 7 further comprises an insulating layer, which is configured on said first side or said second side opposite to said conducting layer.
